(19) United States
(12) Patent Application Publication
(10) Pub. No.: US 2019/0020097 A1
(43) Pub. Date: Jan. 17, 2019

(54) SYSTEM AND METHOD FOR AN ANTENNA POWER TOUCH TRIGGER SYSTEM IN AN INFORMATION HANDLING SYSTEM

(71) Applicant: Dell Products, LP, Round Rock, TX (US)

(72) Inventors: Ching Wei Chang, Austin, TX (US); Kamal J. Koshy, Austin, TX (US)

(73) Assignee: Dell Products, LP, Round Rock, TX (US)

(21) Appl. No.: 15/648,072

(22) Filed: Jul. 12, 2017

(51) Int. Cl. H01Q 1/24; G06F 1/16; G06F 3/044

(52) U.S. Cl. CPC H01Q 1/243; G06K 9/00006; G06F 3/044; G06F 1/1698

(57) ABSTRACT

An information handling system and method comprising a wireless adapter for communicating on an antenna system for connection to an operating wireless link, a display having a touch screen interfacing with a touch screen controller to detect a touch event on the information handling system, a processor executing code instructions for an antenna power touch trigger system for determining whether a location of the touch event is within a threshold distance to the antenna system, and the antenna power touch trigger system communicating an instruction to reduce transmission power of the antenna system if the touch event is located within the threshold distance, wherein the touch event is a detected touch or proximity of a user at a touch screen cell.

### FIELD OF THE DISCLOSURE

The present disclosure generally relates to a method and apparatus for control of wireless transmit power levels of one or more antenna systems in compliance with regulatory specific absorption rate (SAR) requirements for information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, and networking systems. Information handling systems can also implement various virtualized architectures. Data communications among information handling systems may be via networks that are wired, wireless, optical or some combination. For wireless communications, one or more wireless interface adapters may be used including antenna systems, a front end antenna module and other radio frequency subsystems. Several available radiofrequency communication platforms in information handling systems may be operating simultaneously for data and other communications with other users via communication and data networks. As a result, transmission power levels may increased during simultaneous operation requiring control of power levels to maintain SAR regulatory limits for one or more wireless antenna systems operating.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure.

FIG. 2 is a block diagram of a network environment offering several communication protocol options and mobile information handling systems according to an embodiment of the present disclosure;

FIG. 3 graphic diagram illustrating an information handling system with a plurality antenna systems relative to a touch screen according to an embodiment of the present disclosure;

FIG. 4 block diagram illustrating an antenna power touch trigger system according to an embodiment of the present disclosure;

FIG. 5 is a flow diagram illustrating a method of antenna power touch trigger system control of one or more antenna systems to maintain regulatory SAR levels for an information handling system according to an embodiment of the present disclosure; and

FIG. 6 is another flow diagram illustrating operation of an antenna power touch trigger system to maintain regulatory SAR levels for an information handling system according to an embodiment of the present disclosure.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality. The information handling system may be of a variety of models and types. For example, a personal computer may be a laptop, a 360 convertible computing device, a tablet, smart phone, wearable computing device, or other mobile information handling system and may have several configurations and orientation modes. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. In an aspect, the information handling system may have a plurality of antenna systems for communication via wireless links operating on a variety of radio access technologies (RAT). In another aspect, several antenna systems may be available for each RAT to enable aggregated data communications such as via plural multiple in, multiple out (MIMO) streams to enhance bandwidth or reliability. Antenna systems may be operated via one or more wireless adapters that may include controllers, memory and other subsystems some of which may operate as a radio frequency (RF) front end for one or more antenna system to transmit wirelessly. Portions of an information handling system may themselves be considered information handling systems.

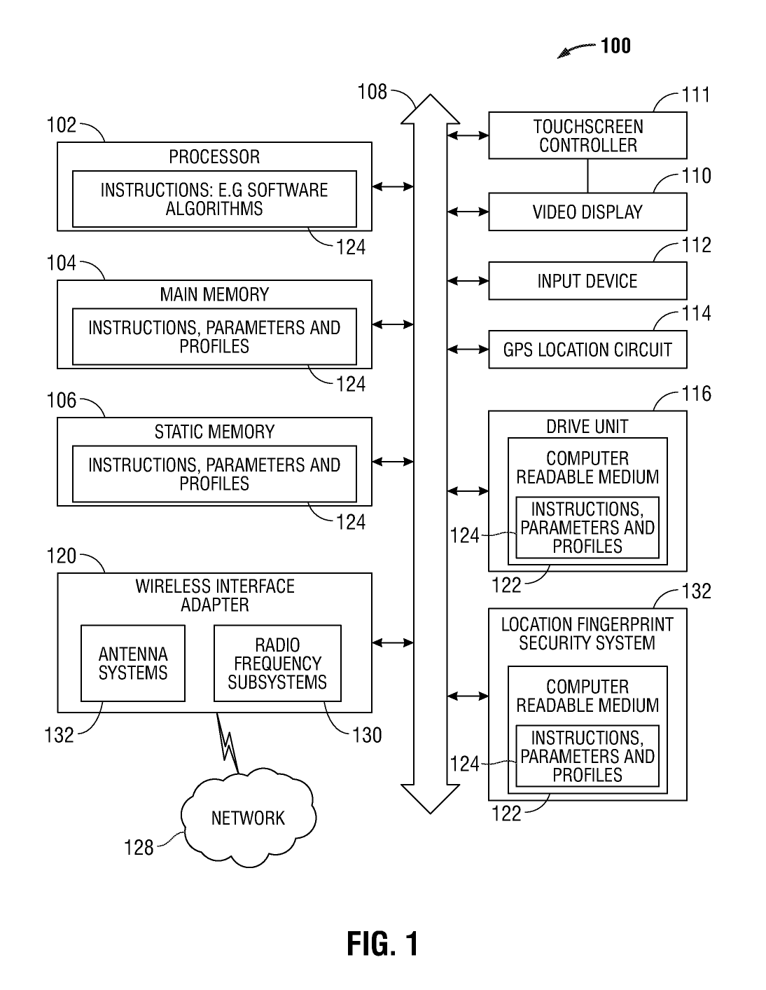

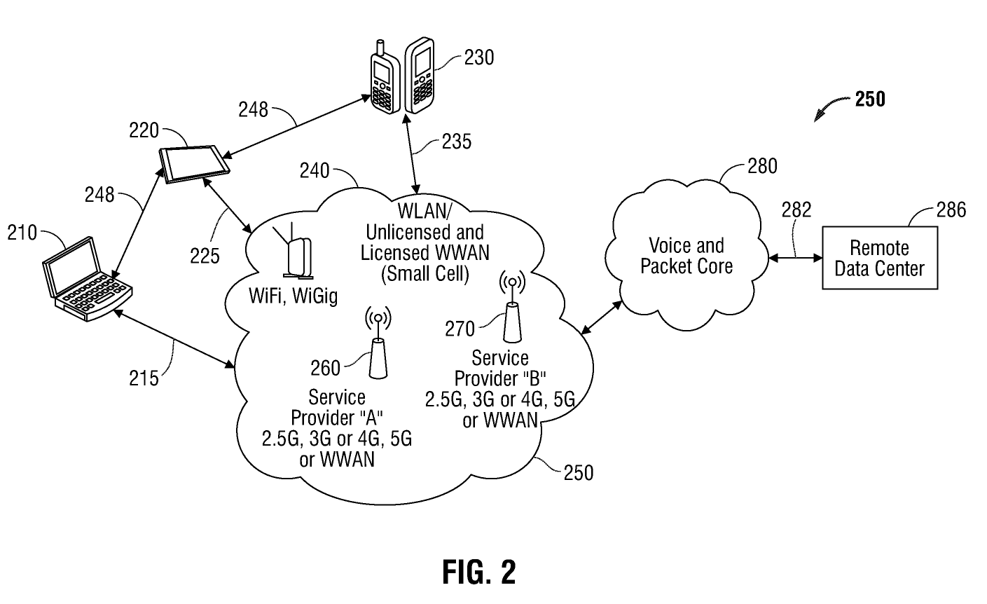

FIG. 1 shows an information handling system 100 capable of administering each of the specific embodiments of the present disclosure. The information handling system 100 can represent the mobile information handling systems 210, 220, and 230 or servers or systems located anywhere within network 200 of FIG. 2, including the remote data centers operating virtual machine applications. Information handling system 100 may represent a mobile information handling system associated with a user or recipient of intended wireless communication. A mobile information handling system may execute instructions via a processor for an antenna power touch trigger system including utilization of touch screen cell activation according to embodiments disclosed herein. The application programs communicating or otherwise operating may operate in some example embodiments as software, in whole or in part, on a mobile information handling system while other portions of the software applications may operate on remote server systems. The antenna power touch trigger system of the presently disclosed embodiments may operate as firmware, software, or hardwired circuitry or any combination on controllers or processors within the information handing system 100 or some of its components such as a wireless interface adapter 120. Information handling system 100 may also represent a networked server or other system and administer aspects of the antenna optimization system via instructions executed on a processor according to various embodiments herein involving remote operation of such systems. The information handling system 100 may include a processor 102 such as a central processing unit (CPU), a graphics processing unit (GPU), or both. Processor 102 may include a chipset that may contain a hub architecture, platform controller hub (PCH), or the like for communication via bus 108 with other components of the information handling system. Moreover, the information handling system 100 can include a main memory 104 and a static memory 106 that can communicate with each other via a bus 108. As shown, the information handling system 100 may further include a video display unit 110, such as a liquid crystal display (LCD), an organic light emitting diode (OLED), a flat panel display, a solid state display, or other display device.

Display 110 may include a touch screen display module and touch screen controller 111 for receiving user inputs to the information handling system 100. Touch screen display module 111 may interface with a grid of capacitance or other detectors to detect a touch interface with the touch screen corresponding to the display screen 110. The sensor grid of the touch screen that interfaces with the touch screen display module 111 and may also be considered to be cells of the touch screen. Touch screen sensor drivers may be located at end points along the grid axes, and activation of these touch screen sensor driver end points may indicate a location on the touch screen and display screen being touched. The location of the touch screen cells activated by touch or proximity may be detected in such a way. This data may be used with the antenna power touch trigger system to control one or more antenna systems according to embodiments of the present disclosure. Touch screen display module 111 may detect touch or proximity to a display screen by detecting capacitance changes in the display screen as understood by those of skill. Touch screen display module 111 may be connected to the display screen 110 as well as interface with the bus 108 for communication with components of the information handling system 100, including an antenna power touch trigger system according to embodiments of the present disclosure.

Additionally, the information handling system 100 may include an input device 112, such as a keyboard, and a cursor control device, such as a mouse or touchpad or similar peripheral input device. The information handling system may include a power source such as battery 114 or an A/C power source. The information handling system 100 can also include a disk drive unit 116, and a signal generation device 118, such as a speaker or remote control. The information handling system 100 can include a network interface device such as a wireless adapter 120. The information handling system 100 can also represent a server device whose resources can be shared by multiple client devices, or it can represent an individual client device, such as a desktop personal computer, a laptop computer, a tablet computer, a 360 degree convertible device, a wearable computing device, or a mobile smart phone.

The information handling system 100 can include a set of instructions 124 that can be executed to cause the computer system to perform any one or more of the methods or computer based functions disclosed herein. For example, instructions 124 may be software applications which utilize one or more wireless links for wireless communications via the wireless interface adapter or adapters as well as other aspects or components. Similarly instructions 124 may be executed as the antenna power touch trigger system disclosed herein for monitoring touch screen activation and wireless links and adjusting wireless power to antenna systems nearby touch or proximity detection events. In some aspects, the antenna power touch trigger system may operate in whole or in part as firmware on a controller within the wireless interface device 120. Instructions 124 may also include aspects of the antenna power touch trigger system described in the present disclosure and operating as firmware or software to remedy or adjust one or more of a plurality of antenna systems 132 via power control over the antenna transmissions. Multiple antenna systems operating on various communication frequency bands may cumulatively be limited in transmission of power levels as determined for specific absorption rate (SAR) limitations under Federal Communication Commission rules and accepted safety standards in the art. Due to the nearness of transmission (and to some degree reception), plural antenna systems in an information handling system 100 have effects on each other. Due to nearness by virtue of physical proximity of the antenna systems, the SAR limits for transmission power are treated for the total power transmitted from the plural, active antenna systems in the information handling system.

Further, the type of information handling system 100 impacts the SAR limits. For example, mobile devices such as mobile smart phones, tablets, laptops may have different SAR limits. Further, SAR limits may depend on the radio access technology being used as well as the configuration of the information handling system 100. For example, WLAN may have an acceptable SAR range of transmission between 0 dBm and 18 dBm whereas a WWAN transmission may operate between 0 dBm and 24 dBm. In some embodiments, a laptop computer may be treated as requiring limits to 1.6 watts per kilogram exposure for surfaces or areas likely to touch a person, such as along the bottom where the laptop may rest on a lap. However a laptop may also remain on a table top during periods of usage. A smart phone or tablet may be assumed to have all surfaces likely to interface with human tissue including the bottom and sides of the display screen where it may be grabbed or held. A 2-in-1 convertible laptop device may behave like a tablet in one configuration and a laptop in a different configuration in some embodiments. Nonetheless, the information handling systems 100 that transmit radiofrequency energy will be subject to safety limits when it is anticipated that the information handling systems 100 will have locations of the transmitting antennas that may come in relative close physical proximity to human tissue of a user. It is understood that greater distance from a transmitting antenna yields substantially reduced exposure and absorption by human tissue.

In some aspects, instructions 124 of a antenna power touch trigger system may execute algorithms to regulate operational power of the one or more antenna systems 132 in the information handling system 100 to avoid exceeding overall transmission power levels. In one aspect, determination of whether an antenna system 132 has an active wireless connection and a user is detected nearby via a touch even, the antenna power touch trigger system may increase power to other active wireless connections on other active antenna systems 132 not nearby the touch event locatoin. In a further aspect of the present embodiments, more than static one-step adjustments to power levels of active wireless antenna systems 132 with a nearby touch event detected which may be conducted by the antenna power touch trigger system.

Various software modules comprising software application instructions 124 or firmware instructions may be coordinated by an operating system (OS) and via an application programming interface (API). An example operating system may include Windows®, Android®, and other OS types known in the art. Example APIs may include Win 32, Core Java API, or Android APIs. In a further example, processor 102 may conduct monitoring and processing of mobile information handling system usage modes by the information handling system 100 according to the systems and methods disclosed herein. The computer system 100 may operate as a standalone device or may be connected such as using a network, to other computer systems or peripheral devices.

In a networked deployment, the information handling system 100 may operate in the capacity of a server or as a client user computer in a server-client user network environment, or as a peer computer system in a peer-to-peer (or distributed) network environment. The information handling system 100 can also be implemented as or incorporated into various devices, such as a personal computer (PC), a tablet PC, a set-top box (STB), a PDA, a mobile information handling system, a tablet computer, a laptop computer, a desktop computer, a communications device, a wireless smart phone, wearable computing devices, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single information handling system 100 is illustrated, the term “system” shall also be taken to include any collection of systems or sub-systems that individually or jointly execute a set, or multiple sets, of instructions to perform one or more computer functions.

The disk drive unit 116 may include a computer-readable medium 122 in which one or more sets of instructions 124 such as software can be embedded. Similarly, main memory 104 and static memory 106 may also contain computer-readable medium for storage of one or more sets of instructions, parameters, or profiles 124. The disk drive unit 116 and static memory 106 also contains space for data storage. Further, the instructions 124 may embody one or more of the methods or logic as described herein. For example, instructions relating to antenna power touch trigger system algorithms or power control policies described in embodiments herein may be stored here or transmitted to local memory located with the wireless interface adapter 132.

In a particular embodiment, the instructions, parameters, and profiles 124 may reside completely, or at least partially, within the main memory 104, the static memory 106, and/or within the disk drive 116 during execution by the processor 102 of information handling system 100. As explained, some or all of the antenna power touch trigger system may be executed locally or remotely. The main memory 104 and the processor 102 also may include computer-readable media. Battery 114 may include a smart battery system that tracks and provides power state data 126. This power state data may be stored with the instructions, parameters, and profiles 124 to be used with the systems and methods disclosed herein.

The network interface device shown as wireless adapter 120 can provide connectivity to a network 128, e.g., a wide area network (WAN), a local area network (LAN), wireless local area network (WLAN), a wireless personal area network (WPAN), a wireless wide area network (WWAN), or other network. Connectivity may be via wired or wireless connection. Wireless adapter 120 may include one or more radio frequency subsystems 130 with transmitter/receiver circuitry, modem circuitry, one or more unified radio frequency front end circuits, one or more wireless controller circuits, amplifiers, antenna systems 132 and other radio frequency subsystem circuitry 130 for wireless communications via multiple radio access technologies. Each radiofrequency subsystem 130 may communicate with one or more wireless technology protocols. The radiofrequency subsystem 130 may contain individual subscriber identity module (SIM) profiles for each technology service provider and their available protocols for subscriber based radio access technologies such as cellular LTE communications. The wireless adapter 120 may also include antenna systems 132 which may be tunable antenna systems for use with the system and methods disclosed herein. Additional antenna transmission power control circuitry (not shown) for controlling power to one or more antenna systems 132 may also be included with the wireless interface adapter 120 to implement power control measures to limit SAR transmission levels as described in various embodiments of the present disclosure. In some aspects of the present disclosure, one wireless adapter 120 may operate two or more wireless links as well.

In some example embodiments, a plurality of antenna systems 132 are controlled via one or a plurality of wireless interface adapters 120. The interface adapters 120 may include baseband controller or other logic to execute portions of the antenna power touch trigger system and to receive power level communication links for anticipated power levels to be used with each antenna system 132 controlled by that interface adapter 120. Plural interface adapters 120 may be connected to each other, connected to the CPU 102 and operating system or both types of connection may exist via one or more communication links via bus 108 or other communication lines. In example embodiments, a universal asynchronous receiver/transmitter (UART) or an enhanced serial peripheral interface bus (eSPI) communication link may be made between the baseband controllers or other power control of a wireless interface adapter 120 for control of one or more wireless antenna systems 132 via portions of the antenna power touch trigger system.

The wireless adapter 120 may operate in accordance with any wireless data communication standards. To communicate, wireless standards including IEEE 802.11 WLAN standards, IEEE 802.15 WPAN standards, WWAN such as 3GPP or 3GPP2, or similar wireless standards may be used. Wireless adapter 120 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac (e.g., center frequencies between 5.170-5.785 GHz). It is understood that any number of available frequency bands may be used each with a plurality of channels. For example, WLAN such as WiFi may operate at a 5 GHz frequency band. WLAN may also operate at a 2.4 GHz band in other examples. WWAN may operate in a number of bands, some of which are propriety but may include a wireless communication frequency band at approximately 2.5 GHz band for example. In additional examples, WWAN carrier licensed bands may operate at frequency bands of approximately 700 MHz, 800 MHz, 1900 MHz, or 1700/2100 MHz for example as well. In the example embodiment, some licensed wireless radio frequency communication capabilities may be available via a subscriber carrier wireless service. With the licensed wireless radio frequency communication capability, WWAN RF front end may operate on a licensed WWAN wireless radio with authorization for subscriber access to a wireless service provider on a carrier licensed frequency band.

The wireless adapter 120 can represent an add-in card, wireless network interface module that is integrated with a main board of the information handling system or integrated with another wireless network interface capability, or any combination thereof. In an embodiment the wireless adapter 120 may include one or more radio frequency subsystems 130 including transmitters and wireless controllers for connecting via a multitude of wireless links. In an example embodiment, an information handling system may have an antenna system transmitter 132 for 5G small cell WWAN, Wi-Fi WLAN or WiGig connectivity and one or more additional antenna system transmitters 132 for wireless communication. The radio frequency subsystems 130 include wireless controllers to manage authentication, connectivity, communications, power levels for transmission, buffering, error correction, baseband processing, and other functions of the wireless adapter 120. Further, one or more wireless adapters 120 may be used to operate several portions of plural antenna systems 132 in an information handling system 100.

The radio frequency subsystems 130 of the wireless adapters may also measure various metrics relating to wireless communication pursuant to operation of the antenna power touch trigger system as in the present disclosure. For example, the wireless controller of a radio frequency subsystem 130 may manage detecting and measuring modem activity for an antenna system 132, received signal strength levels, bit error rates, signal to noise ratios, latencies, jitter, and other metrics relating to signal quality and strength. In one embodiment, a wireless controller of a wireless interface adapter 120 may manage one or more radio frequency subsystems 130. The wireless controller also manages transmission power levels which directly affect radio frequency subsystem power consumption as well as transmission power levels from the plurality of antenna systems 132. The transmission power levels from the antenna systems 132 may be relevant to specific absorption rate (SAR) safety limitations for transmitting mobile information handling systems. To control and measure power consumption via a radio frequency subsystem 130, the radio frequency subsystem 130 may control and measure current and voltage power that is directed to operate one or more antenna systems 132.

The wireless network may have a wireless mesh architecture in accordance with mesh networks described by the wireless data communications standards or similar standards in some embodiments but not necessarily in all embodiments. The wireless adapter 120 may also connect to the external network via a WPAN, WLAN, WWAN or similar wireless switched Ethernet connection. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The present disclosure contemplates a computer-readable medium that includes instructions, parameters, and profiles 124 or receives and executes instructions, parameters, and profiles 124 responsive to a propagated signal; so that a device connected to a network 128 can communicate voice, video or data over the network 128. Further, the instructions 124 may be transmitted or received over the network 128 via the network interface device or wireless adapter 120.

Information handling system 100 includes one or more application programs 124, and Basic Input/Output System and firmware (BIOS/FW) code 124. BIOS/FW code 124 functions to initialize information handling system 100 on power up, to launch an operating system, and to manage input and output interactions between the operating system and the other elements of information handling system 100. In a particular embodiment, BIOS/FW code 124 reside in memory 104, and include machine-executable code that is executed by processor 102 to perform various functions of information handling system 100. In another embodiment (not illustrated), application programs and BIOS/FW code reside in another storage medium of information handling system 100. For example, application programs and BIOS/FW code can reside in drive 116, in a ROM (not illustrated) associated with information handling system 100, in an option-ROM (not illustrated) associated with various devices of information handling system 100, in storage system 107, in a storage system (not illustrated) associated with network channel of a wireless adapter 120, in another storage medium of information handling system 100, or a combination thereof. Application programs 124 and BIOS/FW code 124 can each be implemented as single programs, or as separate programs carrying out the various features as described herein.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

FIG. 2 illustrates a network 200 that can include one or more information handling systems. In a particular embodiment, network 200 includes networked mobile information handling systems 210, 220, and 230, wireless network access points, and multiple wireless connection link options. A variety of additional computing resources of network 200 may include client mobile information handling systems, data processing servers, network storage devices, local and wide area networks, or other resources as needed or desired. As specifically depicted, systems 210, 220, and 230 may be a laptop computer, tablet computer, 360 degree convertible systems, wearable computing devices, or a smart phone device. These mobile information handling systems 210, 220, and 230, may access a wireless local network 240, or they may access a macro-cellular network 250. For example, the wireless local network 240 may be the wireless local area network (WLAN), a wireless personal area network (WPAN), or a wireless wide area network (WWAN). In an example embodiment, LTE-LAA WWAN may operate with a small-cell WWAN wireless access point option.

Since WPAN or Wi-Fi Direct Connection 248 and WWAN networks can functionally operate similar to WLANs, they may be considered as wireless local area networks (WLANs) for purposes herein. Components of a WLAN may be connected by wireline or Ethernet connections to a wider external network. For example, wireless network access points may be connected to a wireless network controller and an Ethernet switch. Wireless communications across wireless local network 240 may be via standard protocols such as IEEE 802.11 Wi-Fi, IEEE 802.11ad WiGig, IEEE 802.15 WPAN, or emerging 5G small cell WWAN communications such as eNodeB, or similar wireless network protocols. Alternatively, other available wireless links within network 200 may include macro-cellular connections 250 via one or more service providers 260 and 270. Service provider macro-cellular connections may include 2G standards such as GSM, 2.5G standards such as GSM EDGE and GPRS, 3G standards such as W-CDMA/UMTS and CDMA 2000, 4G standards, or emerging 5G standards including WiMAX, LTE, and LTE Advanced, LTE-LAA, small cell WWAN, and the like.

Wireless local network 240 and macro-cellular network 250 may include a variety of licensed, unlicensed or shared communication frequency bands as well as a variety of wireless protocol technologies ranging from those operating in macrocells, small cells, picocells, or femtocells.

In some embodiments according to the present disclosure, a networked mobile information handling system 210, 220, or 230 may have a plurality wireless network interface systems capable of transmitting simultaneously. Example competing protocols may be wireless network access protocols such as Wi-Fi, WiGig, and WWAN in an unlicensed and licensed communication frequency bands. Access to a plurality of wireless networks 240 and 250 access points (APs) for Wi-Fi or WiGig as well as WWAN connectivity may be available in emerging 5G technology. This may create situations where a plurality of antenna systems are operating on a mobile information handling system 210, 220 or 230 via concurrent active wireless links on both WLAN and WWAN and which may operate within the same, adjacent, or other plural antenna systems. Such issues may be addressed or mitigated with remedies according to the antenna power touch trigger system to limit power levels for SAR exposure according to embodiments herein.

The voice and packet core network 280 may contain externally accessible computing resources and connect to a remote data center 286. The voice and packet core network 280 may contain multiple intermediate web servers or other locations with accessible data (not shown). The voice and packet core network 280 may also connect to other wireless networks similar to 240 or 250 and additional mobile information handling systems such as 210, 220, 230 or similar connected to those additional wireless networks. Connection 282 between the wireless network 240 and remote data center 286 or connection to other additional wireless networks may be via Ethernet or another similar connection to the world-wide-web, a WAN, a LAN, another WLAN, or other network structure. Such a connection 282 may be made via a WLAN access point/Ethernet switch to the external network and be a backhaul connection. The access point may be connected to one or more wireless access points in the WLAN before connecting directly to a mobile information handling system or may connect directly to one or more mobile information handling systems 210, 220, and 230. Alternatively, mobile information handling systems 210, 220, and 230 may connect to the external network via base station locations at service providers such as 260 and 270. These service provider locations may be network connected via backhaul connectivity through the voice and packet core network 280.

Remote data centers may include web servers or resources within a cloud environment that operate via the voice and packet core 280 or other wider internet connectivity. For example, remote data centers can include additional information handling systems, data processing servers, network storage devices, local and wide area networks, or other resources as needed or desired. Having such remote capabilities may permit fewer resources to be maintained at the mobile information handling systems 210, 220, and 230 allowing streamlining and efficiency within those devices. Similarly, remote data center permits fewer resources to be maintained in other parts of network 200.

In an example embodiment, the cloud or remote data center or networked server may run hosted applications for systems 210, 220, and 230. For example, remote data center, networked server, or some combination of both may operate some or all of a antenna power touch trigger system in embodiments of the present disclosure including storing a touch cell location matrix particular to the various models of information handling system 100 or updates of the same as disclosed in the present disclosure. The cloud or remote data center or networked server may run hosted applications for systems 210, 220, and 230 by establishing a virtual machine application executing software to manage applications hosted at the remote data center in an example embodiment. Mobile information handling systems 210, 220, and 230 are adapted to run one or more applications locally, and to have hosted applications run in association with the local applications at remote data center or networked servers. For example, mobile information handling systems 210, 220, and 230 may operate some or all of the antenna power touch trigger system or software applications utilizing the wireless links, including a concurrent wireless links, in some embodiments. The virtual machine application may serve one or more applications to each of mobile information handling system 210, 220, and 230. Thus, as illustrated, systems 210, 220, and 230 may be running applications locally while requesting data objects related to those applications from the remote data center via wireless network. In another example, an electronic mail client application may run locally at system 210. The electronic mail client application may be associated with a host application that represents an electronic mail server. In another example, a data storage client application such as Microsoft Sharepoint may run on system 220. It may be associated with a host application running at a remote data center that represents a Sharepoint data storage server. In a further example, a web browser application may be operating at system 230. The web browser application may request web data from a host application that represents a hosted website and associated applications running at a remote data center.

Although 215, 225, and 235 are shown connecting wireless adapters of mobile information handling systems 210, 220, and 230 to wireless networks 240 or 250, wireless communication may link through a wireless access point (Wi-Fi or WiGig), through WWAN small cell base stations such as in network 240 or though a service provider tower such as that shown with service provider A 260 or service provider B 270 and in network 250. In other aspects, mobile information handling systems 210, 220, and 230 may communicate intra-device via 248 when one or more of the mobile information handling systems 210, 220, and 230 are set to act as a access point or even potentially an WWAN connection via small cell communication on licensed or unlicensed WWAN connections. For example, one of mobile information handling systems 210, 220, and 230 may serve as a Wi-Fi hotspot in an embodiment. Concurrent wireless links to information handling systems 210, 220, and 230 may be connected via any access points including other mobile information handling systems as illustrated in FIG. 2.

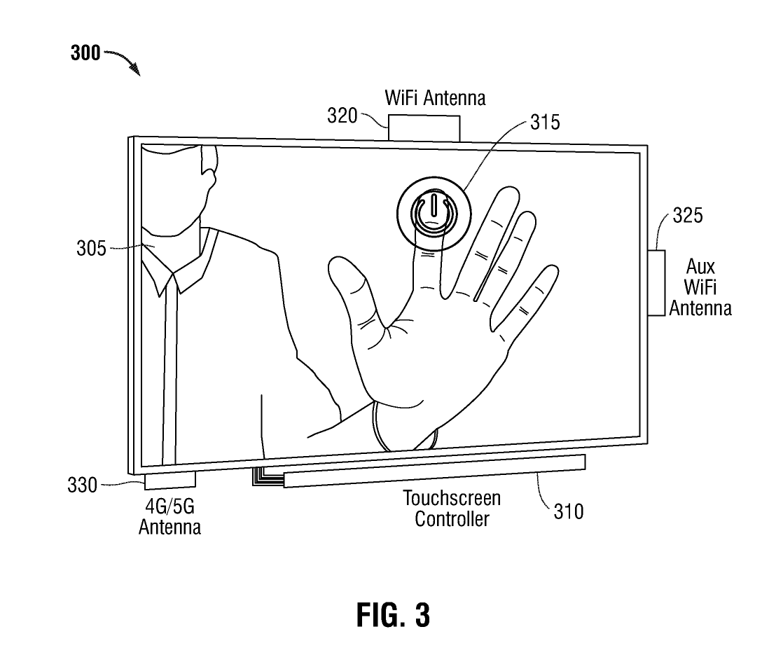

FIG. 3 illustrates an antenna power touch trigger system operating on an information handling system 300 with a touch screen display 305 and implementing one or more antenna systems 320, 325, and 330 according to an embodiment. In an example aspect, the information handling system 300 may be any mobile information handling system operating one or more wireless links via a plurality of antenna systems and a touch screen display screen 305 with a touch screen controller 310. The antenna power touch trigger system may be implementable in a variety of models of information handling systems 300 with multiple architectures having location of one or a plurality of antenna systems, such as 320, 325, and 330, located around or near a display screen 305. The information handling system 300 may be a tablet computer, a smart phone, a laptop computer, a 2 in 1 convertible device, a wearable computing device, or other type of wireless information handling system with a touch interactive display screen 305 in various embodiments.

Antenna mounting location and utilization of auxiliary transmission/reception surfaces such as information handling system chassis or case components may vary between model types of information handling system 300. The locations of the one or a plurality of antenna systems, such as 320, 325, and 330, relative to the touch interactive display 305 determines a customized antenna power touch trigger system operating for each model information handling system 300, and thus the locations of a touch screen cell, such as 315, which may activate power reduction measures for a nearby antenna system may be similarly customized. Touch screen controller 310 will operate according to understood operation, however a touch cell location matrix for each type of information handling system 300 may be developed to identify when a touch event at a touch screen cell such as 315 is located within a threshold distance of one or more antenna systems. Each type of an information handling system 300 produced by a manufacturer according to embodiments herein may have distinct touch cell location matrix data applied to the variations in antenna locations. The touch cell location matrix may vary with the antenna system mounting locations in or on the information handling system. The threshold distance between touch screen cells and wireless antenna locations may be determined for maintaining required dosimetry limits of RF transmitted radiation from nearby antenna systems. It is understood that distance to a transmitter relates to dosimetry levels from a transmitter such as the antenna systems, such as 320, 325, and 330. Thus, the antenna power touch trigger system may accommodate the differences in antenna locations for various architectures of concurrently operating antennas via customized touch cell location matrices and threshold distances.

An information handling system 300 may include several types of antenna systems as described above. In the shown example embodiment, a WiFi antenna 320 and an auxiliary WiFi antenna 325 may be a plurality of WLAN antennas operating on the information handling system 300. Additionally, a WWAN cellular or other antenna system 330 may be operating under 2G, 3G, 4G, 5G or other WWAN protocols. Likewise, WiGig, Bluetooth and other wireless protocols may operate via antenna systems from a plurality of radio access technologies (RATs) in WLAN, WWAN, WPAN or the like on information handling system 300. One or more active antenna systems may require control over transmission power levels to maintain FCC SAR limits on transmission power near human tissue interacting with the information handling system 300. Moreover, concurrent antenna operation may occur in the information handling system and be within the same radio access technology or protocol, such as plural cellular connections or with MIMO or other aggregation connectivity, or through plural antennas operating on multiple protocols on the information handling system. Further aspects of the antenna power touch trigger system control over transmission power with respect to activated touch screen cells and one or more active antenna systems is also described in embodiments herein.

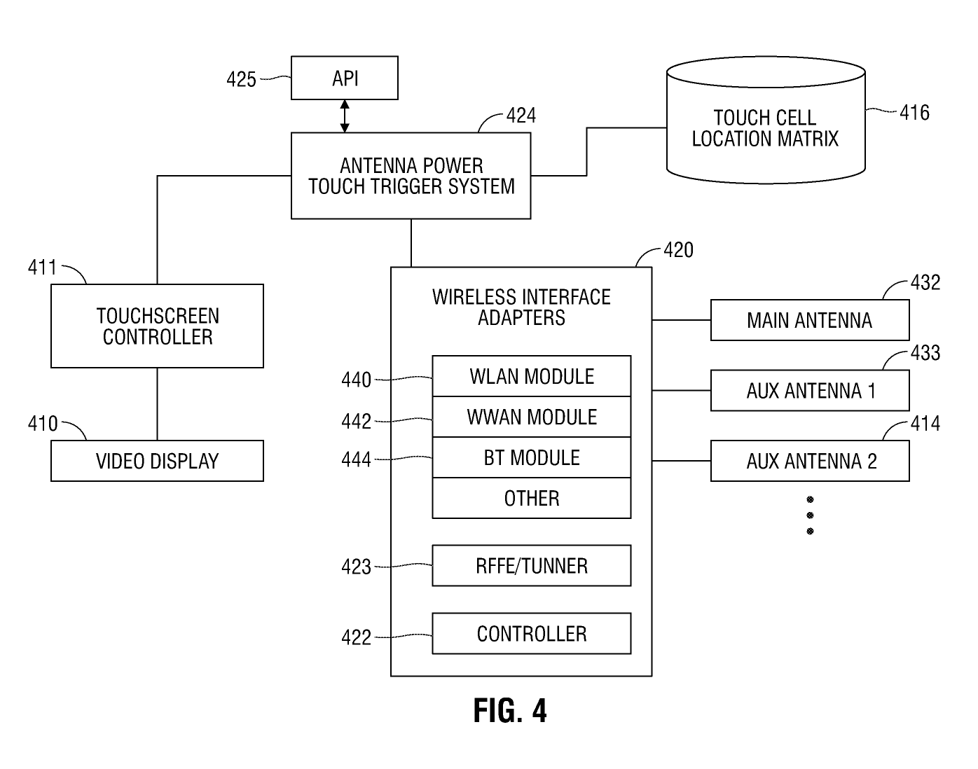

FIG. 4 illustrates a system block diagram of an aspect of an antenna power touch trigger system 424 in operation on an information handling system. The information handling system of FIG. 3 may execute code to operate antenna power touch trigger system 424 that coordinates collection of touch screen cell activation data and antenna power control in an information handling system.

The antenna power touch trigger system 424 may be executable code instructions in software, firmware, or may be code instructions hardwired into an ASIC, FPGA or any combination of the above. The antenna power touch trigger system 424 may coordinate with a touch screen controller 411 to receive touch screen cell location information for activated touch screen cells when a user touches a display screen 410 with touch screen capability. The touch sensing location capability for the touch screen and controller 411 may include touches or proximity detection in some embodiments. Further, the touch sensing location capability for the touch screen controller may also detect touch or proximity along edges of a display screen 410 in some embodiments. Indication of user touches to the display screen 410 or proximity to edges along a display screen 410 by touch screen controller 411 is useful due to locations of wireless antenna systems that are often along the edges or the bezel of a display screen in information handling systems in some embodiments.

Antenna power touch trigger system 424 may also interface with one or more wireless interface adapters 420 and adapter sub-systems such as 440, 442, 444 for wireless protocol modules, and the wireless interface adapter radio frequency front end circuitry (RFFE) 423 which may include tuners and control circuitry to interface with a plurality of antenna systems for signal generation, carrier generation, modulation/demodulation, tuning, switching, and the like. One of more antenna systems may be deployed and mounted on the information handling system. In some particular embodiments, the antenna systems may be mounted around, behind, or otherwise on or in a housing that houses display 410. In the example embodiment, a main antenna system 432 may operate via one protocol type and there may be an additional auxiliary antenna system 433 of the same or a different protocol type. Additional antenna systems 434 may also be deployed on the information handling system and may be of a variety of wireless protocol types.

It is understood that a wireless adapter 420 may be utilized with antenna systems deployed with similar protocol types and for particular frequency bands. For example, one wireless adapter 420 may be designated for WWAN protocol antenna systems and transmissions while different wireless adapters 420 may be implemented for other protocols such as WLAN or WPAN protocols. In other embodiments, several WWAN protocols may be utilized, such as from various service providers, and one or more wireless adapters 420 may be deployed to accommodate differing licensed radio frequency bands and communication layer protocols used within each WWAN wireless link. Similarly, within WLAN, WPAN or other general protocol types, one or more wireless adapters 420 may be used. By the same token, it is contemplated that plural wireless adapters may be co-located or consolidated into a single wireless adapter 420 capable of interfacing with a plurality of wireless protocols and antenna systems.

Additionally the one or more wireless interface adapters may implement one or more controllers such as microcontroller units (MCUs) and other controllers. The MCUs and other controllers are used to execute functions from application of various OSI layers for incoming or outgoing transmissions, tuning, and several operations including the operation of the RFFE functions as well.

As described, the antenna power touch trigger system 424 may comprise a set of instructions run on a CPU or embedded in a controller in the chipset(s) or in the wireless interface adapter in whole or in parts. The antenna power touch trigger system 424 interfaces with the application programming interface (API) 425 found in the information handling system software to coordinate various software applications including the antenna power touch trigger system 424, related modules for process location of activated touch screen cells from touch screen controller 411, and touch cell location matrix data repository 416 for storing data indicating touch screen cells and location distance from mounted antenna systems for particular information handling system types in various embodiments. Further, touch cell location matrix data repository 416 may include threshold distance information for touch screen cells relative to mounted antenna systems based on transmission power levels from those antenna systems. It is understood that the transmission power levels also impact dosimetry levels along with distance proximity to a transmitter.

The API 425 may further coordinate the antenna power touch trigger system 424, the drivers and data collection from the touch screen controller 411, the drivers and communication with the one or more wireless interface adapters 420, and other software or firmware systems in an information handling system.

The antenna power touch trigger system 424 obtains touch screen cell location data as detected via the touch screen controller 411. With this touch screen cell location data, the antenna power touch trigger system 424 may cross reference the touch cell location matrix 416 and determine whether an activated touch screen cell location, activated for touch or proximity of a user, is within a threshold distance of one or more antenna system mounting locations. If it is determined that the activated touch screen cell location indicates a touch or proximity of a user within a threshold distance of at least one mounted and transmitting antenna system, the antenna power touch trigger system 424 communicates instructions to the one or more wireless interface adapters 420. The one or more wireless interface adapters 420 may be instructed by the antenna power touch trigger system 424 to reduce, enter standby mode, or turn off a transmitter proximate to the detected touch cell location that has been activated by a touch or proximity of the user. This reduction in power or cancellation of transmission power may be applied to one or more antenna systems on the information handling system in some embodiments. The antenna systems may operate on the same or varied protocols such as the wireless communication link types described herein.

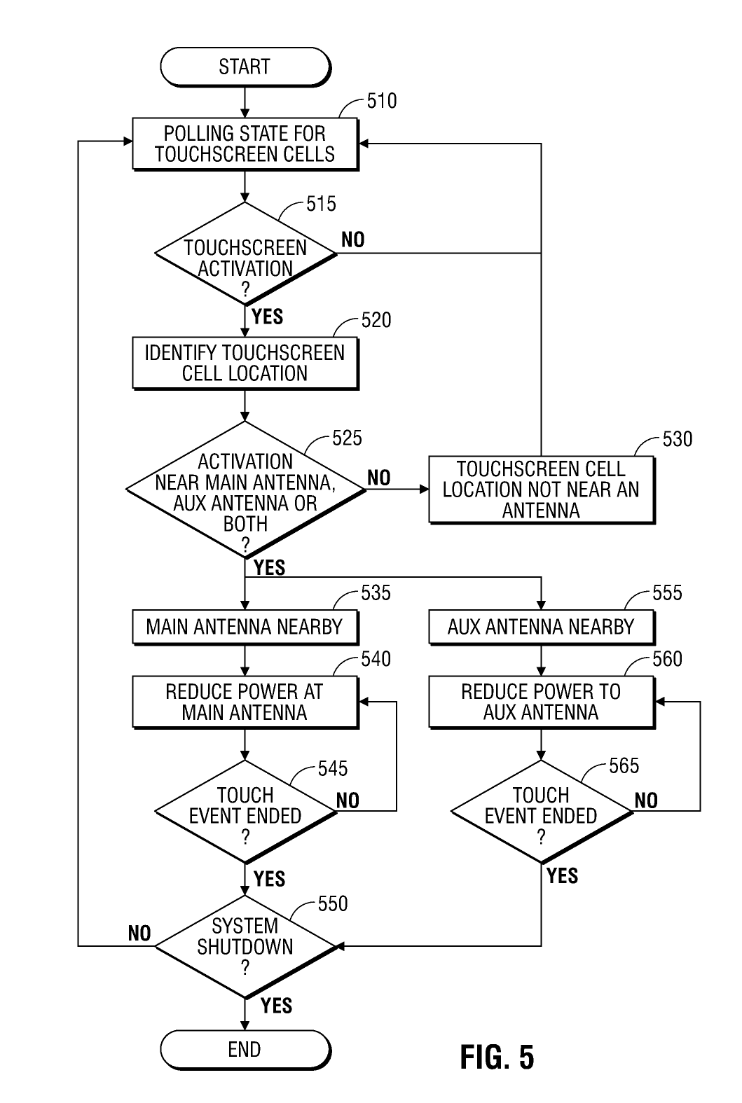

FIG. 5 illustrates a method for determining antenna power adjustments to reduce SAR exposure for one or more of a plurality of operating antenna systems via an antenna power touch trigger system according to an embodiment of the present disclosure. At 510, in this example embodiment, one or more wireless links may be utilized in an information handling system during system operation. An antenna power touch trigger system executed as machine readable code, such as software, firmware or hard wired instructions, may coordinate operation of a the one or more active antenna systems operational in the information handling system. The antenna power touch trigger system may be tailored to apply to the antenna mounting architecture of any model type of mobile information handling system as described above. Additionally, the information handling system may concurrently use two or more wireless links on one or several radiofrequency communication bands and across a variety of RATs utilizing one or more antenna systems concurrently as described in various embodiments of the present disclosure. For example, a mobile information handling system may utilize WLAN and WWAN wireless links within a shared communication bands or at various bands which may have SAR dosimetry effects between the wireless links due to harmonics, similar transmission frequencies, or other factors that may cause enhanced transmission power levels for radio frequency radiation in the communication on the one or more antenna systems.

At 510, the antenna power touch trigger system interface with a touch screen system including a touch screen controller to conduct periodic or ongoing polling for states of the touch screen activation. The touch screen and touch screen controller may systematically report the state of activated touches or proximity detection by the touch screen, or may only notify the antenna power touch trigger system when a touch or proximity detection is made. Nonetheless, the antenna power touch trigger system operates in a state of monitoring or polling for indications of a touch or a proximity detection by the touch screen.

In another embodiment of the present disclosure, but not shown in FIG. 5, the antenna power touch trigger system may also poll or monitor for whether one or more antenna systems operated by one or more wireless interface adapters are active. As part of the polling or monitoring, the antenna power touch trigger system may poll or receive indications from the one or more wireless interface adapters as to which antenna systems are active in transmission or will be active in transmission. For example, activation of modems for a particular wireless protocol and connection to an antenna system or other wireless link activity of a wireless interface adapter may be detected. Activation of a type of modem indicating which radio frequency communication band is being used may indicate an active corresponding antenna system.

Proceeding to 515, the polling or monitoring status of the antenna power touch trigger system will determine whether an indication of a touch or proximity detection has been made. If not, the flow returns to 510 to continue polling or monitoring for a touch screen cell activation. If the touch screen controller indicates a touch screen cell has activated, then flow proceeds to 520 where the touch screen controller provides the coordinates of the activated touch screen cell location. In an example embodiment, the x and y location of the touch screen sensor grid may indicate the relative position of the touch or the proximity detection on the display device. This is a function of the touch screen controller for utilization of the touch screen as an input device. It is further understood that the touch screen controller may provide those coordinates of activation for either a detected touch or a detected proximity of a user near the touch screen. The touch screen may operate via a grid of capacitive sensing elements or cells or other touch sensing systems as known in the art.

At 525, the antenna power touch trigger system determines whether an activated touch screen cell is located near either any active antenna system. In an example embodiment, active antenna systems may include a main antenna and an auxiliary antenna. These antennas may operate on the same radiofrequency communication protocols or differing protocols and on any frequency band. In the presently described embodiment, two active antenna systems are described, but it is understood that any number of mounted, active antenna systems may be monitored by the antenna power touch trigger system.

The antenna power touch trigger system will cross reference the location or coordinates of the detected activated touch screen cell with a touch cell location matrix. As described, the touch cell matrix data indicates locations and distances of mounted antenna systems and identifies the mounted antenna systems for determination by the antenna power touch trigger system that they are active for transmission. The touch cell location matrix data will also indicate a threshold distance from a mounted antenna system or antenna systems within which dosimetry proximity risk increased. If the active touch cell is not within any threshold range of any active antenna systems, the antenna power touch trigger system will proceed to 530 where it is determined that a detected user touch or proximity is not near enough to a transmitting antenna. Accordingly, the antenna power touch trigger system will return to 510 to continue monitoring or polling the wireless interface adapter or adapters for active antenna systems and the touch screen controller for detected touches or proximity indications from the touch screen.

If the active touch cell is within a certain threshold range of one or more mounted, active antenna systems, the antenna power touch trigger system will proceed to send instructions to the corresponding wireless interface adapters to adjust power levels for those active antenna systems. The flow may proceed to 535 where a determination is made that an active touch cell indicates a user touch or proximity is within a threshold range of a main antenna system that is active and mounted near the activated touch screen cell.

At 540, the antenna power touch trigger system will instruct the corresponding wireless interface adapter to reduce power for transmission by the main antenna to a preset lower level that will reduce the risk of a user receiving 1.6 watts per kilogram exposure on human tissue within the distance threshold range of the main antenna. In some embodiments, multiple range threshold levels or steps may be indicated which may turn down the power to the main antenna in steps depending upon which distance range within which the touch or proximity is detected. Further, one of those steps of power reduction, such as for a closest range to the main antenna, may place the antenna system into standby or to shut off power for transmission by the main antenna. It is understood that variations on this gradual power reduction based on nearness of a detected touch event or proximity detection to a mounted antenna is contemplated. For example, the power reduction of the main antenna at 540 may be gradual as the detected active touch cell is closer to the location of the mounted main antenna or it may be stepped in any number of steps. The wireless interface adapter, upon receiving an instruction to reduce the power level for the main antenna, may then execute the instruction via a controller in the radio frequency front end or elsewhere to adjust the power levels of transmission of the main antenna system.

Flow may proceed to 545 where the antenna power touch trigger system determines whether the touch event has ended. In other words, the antenna power touch trigger system may interface with the touch screen controller to ascertain whether the indication of a touch activation or a proximity detection has ended or is no longer ongoing. If the touch event, including a proximity event is detected not to have ended or changed, flow returns to 540 where the power reduction measures will be continued by the antenna power touch trigger system. If however, the touch event, including a proximity detection event, has ended, then flow will proceed to 550.

At 550, the antenna power touch trigger system will determine if the information handling system is shutting down. If so, the process may end. If not, flow will proceed back to 510 to continue monitoring or polling by the antenna power touch trigger system.

If the active touch cell is within a certain threshold range of an active auxiliary antenna system, the antenna power touch trigger system will proceed to send instructions to the corresponding wireless interface adapter to adjust power levels for the active auxiliary antenna system. The flow may proceed to 555 where it is determined that an active touch cell indicates a user touch or proximity within a threshold range of the auxiliary antenna system.

At 560, the antenna power touch trigger system will instruct the corresponding wireless interface adapter to reduce power for transmission by the main antenna to a preset lower level that will reduce the risk of a user receiving high levels of RF radiation above the SAR limits. In some embodiment, multiple threshold distance levels or a continuous distance correlation to the transmitting auxiliary antenna may indicate whether and how much to turn down the power to the auxiliary antenna. In one aspect, one steps of power reduction may include placing the auxiliary antenna into a standby mode or shutting off power for transmission. It is contemplated that variations on gradual power reduction may be used in some embodiments based on nearness of a detected touch event or proximity detection to a mounted auxiliary antenna.

The wireless interface adapter, upon receiving an instruction to reduce the power level for the auxiliary antenna may then execute the instruction at 560 via a controller in the radio frequency front end or elsewhere to adjust the power levels of transmission of the auxiliary antenna system. The antenna power touch trigger system may determine that an activated touch screen cell is near the main antenna, the auxiliary antenna, or both in some embodiments. In some embodiments, power level adjustments may be made by the antenna power touch trigger system to either or both of the main and auxiliary antenna systems if the touch event is within threshold distances of either or both respectively. It is understood that the embodiment of FIG. 5 discloses an antenna power touch trigger system controlling power for two antenna systems, a main antenna and an auxiliary antenna, but one or any plurality of antenna systems may be under power control based on touch events detected near the antenna systems.

Flow may proceed to 565 where the antenna power touch trigger system determines whether the touch event has ended and no touch or proximity is detected at the touch screen cell near the auxiliary antenna. The antenna power touch trigger system may interface with the touch screen controller to determine if the touch event has ended. If the touch event, including a proximity event, has not ended or changed, then flow returns to 560 where the power reduction measures for the auxiliary antenna will be continued. If the touch event, such as a touch or proximity detection, has ended however, then flow will proceed to 565 in an embodiment.

At 550, the antenna power touch trigger system will determine if the information handling system is shutting down. If so, the process may end. If not, flow will proceed back to 510 to continue monitoring or polling by the antenna power touch trigger system as before.

The antenna power touch trigger system may reduce power to a plurality of antenna systems. The number of antenna systems and the power levels at which transmission is occurring may determine or affect how much power may be used to transmit from each of the plurality of antenna systems. Additionally, the specific absorption rate safety limitations depend in part on the type of device such as a laptop, desktop docked device, tablet, or mobile smart phone utilizing the plurality of antenna systems. Each type may be subject to differing power transmission level limitations due to differing risks of contact with human tissue. Nonetheless dosimetry must generally be held to below 1.6 watts per kilogram of exposure.

Generally, performance of antenna systems is improved if greater transmission power is permitted. However, this is limited in part by controls over SAR levels by the antenna power touch trigger system to avoid a user's exposure to human tissue of a head, hand, lap or other body part. Avoiding reduction of antenna power transmission levels unless a user is in close proximity to an antenna system will permit the antenna system to operate at higher power and with greater reliability and service quality. Thus, the antenna power touch trigger system may provide for reduction in transmission power at antennas only when it is necessary.

It is understood that the methods and concepts described in the algorithm above for FIG. 5 may be performed in any sequence or steps may be performed simultaneously in some embodiments. It is also understood that in some varied embodiments certain steps may not be performed at all or additional steps not recited in the above figures may be performed. It is also contemplated that variations on the methods described herein may also be combined with portions of any other embodiments in the present disclosure to form a variety of additional embodiments.

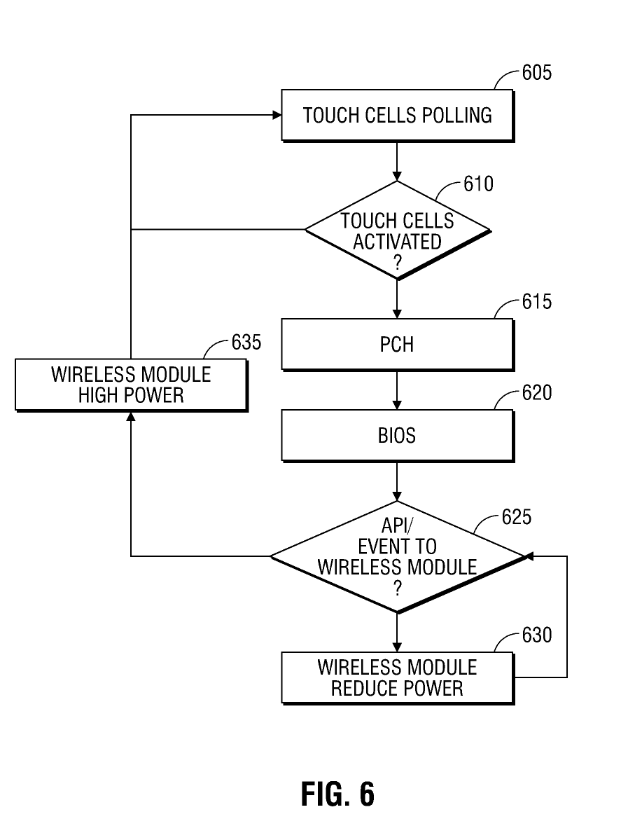

FIG. 6 illustrates another method for determining antenna power adjustments to reduce SAR exposure for one or more of a plurality of concurrently operating antenna systems via an antenna power touch trigger system according to an embodiment of the present disclosure. At 605, in this example embodiment, one or more wireless links may be active in a mobile information handling system. The antenna power touch trigger system may poll touch cells of the touch screen system to determine if touch events are occurring due to touch or proximity on the information handling system. This polling may instead involve monitoring touch screen data indicating touch events from a touch screen controller. The ongoing monitoring for the antenna power touch trigger system will assess when and where the touch events are occurring on the information handling system.

At 610, the antenna power touch trigger system determines whether touch cells on the touch screen are activated. If not, flow returns to 605 to continue monitoring or polling. If touch cells are determined to be activated, flow proceeds to 615. At 615, the signal indicating a touch cell activation due to a touch or a proximity detection event is sent to the platform controller hub (PCH) for the processor chipset via a bus from the touch screen controller. As used herein, a touch or proximity detection event may be referred to as a touch event. The cell activation data may indicate whether a touch or proximity has been detected by the touch screen and the location of the touch event in the sensor grid of the touch screen. This data may be ongoing information provided by the touch screen controller until the touch event has ended or changes. In some embodiments, the touch screen controller may provide additional data relating to location of the touch event, confidence levels of the touch event, trajectory information or the like.

The PCH receives the touch screen controller data indicating a touch event data from the touch screen controller at 615. The touch event data is passed via BIOS at 620 for interpretation of the touch screen information by the antenna power touch trigger system. The antenna power touch trigger system may operate, in part, in BIOS or via a software application operating on the CPU chipset in an embodiment. The BIOS at 620 may interface with software operating on a central processor. In other embodiments, the antenna power touch trigger system may operate via a processor or controller located in one or more wireless interface adapters in communication with each other or in communication with the PCH and chipset.

At 620, the antenna power touch trigger system may cross reference a touch cell location matrix to determine if the touch event falls within or will fall within a threshold distance from one or more active antenna systems. Future prediction based on trajectory of touch screen activity may be used in some embodiments when a touch event approaches a threshold distance toward a location of an antenna system. Determination of threshold distances for a touch cell activation may be specific to the architecture of each information handling system in which a antenna power touch trigger system operates. The threshold distances for touch cells depend on the architecture for mounted antenna systems with respect to edges and location of the display screen with touch screen capability. Further, the threshold distances may depend on the type of transmitter for each antenna system mounted on the information handling system and the type of wireless link operating during transmissions. In most cases, a maximum of 1.6 watts per kilogram exposure for surfaces or areas likely to touch a person is the limit. Thus, in an example embodiment, a threshold distance may be set at any relatively close distance from the transmitter mounting location. In an example embodiment, the threshold distance may be 5 cm. In another embodiment, a threshold distance may be 10 cm. The threshold may be at any distance from the antenna systems as determined for the 1.6 watts per kilogram exposure for surfaces or areas likely to touch a person and for use by the antenna power touch trigger system. In additional embodiments, several threshold distances may be relevant to setting a plurality of power reduction levels or a spectrum of power reduction as a touch event is detected progressively closer to an antenna system. Several antenna distance thresholds may be cross-referenced with a touch cell location matrix at 620 by the antenna power touch trigger system.

At 625, the antenna power touch trigger system will determine if a threshold level has been triggered such that a touch event indicating proximity or a touch located near one or more antenna systems has been detected. If so, the antenna power touch trigger system code instructions may issue an instruction to a wireless interface adapter wireless module of the touch event and the need to reduce power. In an example embodiment, an Application Programming Interface (API) may communicate the detection of a proximity touch and associate it as within a threshold of a nearby antenna system. The antenna power touch trigger system may interface with a wireless module or front end controller of the corresponding nearby antenna system or systems via the API. The nearness detection may trigger a command to provide for power control by the operating system and the antenna power touch trigger system software. This command or instruction may invoke one of several power levels for the one or more antenna systems near the detected touch event that is within the proximity threshold to the antenna system in some embodiments. In an example embodiment, a plurality of power reduction levels may be invoked in reducing the transmission power level of the antenna from a full power level permitted by FCC SAR regulations. For example, several proximity power levels may trigger more reduced intermediate transmission power state instructions to provide for progressively reduced transmission power levels to an antenna system where a touch event has been detected nearby within each threshold range. Another power reduction state may be a state where the antenna system is put into standby mode where it is still responsive to commands or where the antenna system is powered down such as with a touch on top of the antenna system. Additional levels are contemplated in some embodiments. The reduce power device states may be selected and determined for any reduced power level. The amount of power reduction levels states may be set to reduce the transmission power levels based on antenna orientation or location, the type of transmission, and other factors. Control instructions for the transmission power levels is executed by the wireless module or the front end controller of the wireless antenna system in various embodiments.

If at 625, no power reduction is required since no threshold has been triggered by a touch event, flow proceeds to 635 where the wireless interface adapter or adapters are permitted to operate at highest available power levels within the limits of FCC SAR regulations. If at 625, a power reduction is required, then flow proceeds to 630 where the antenna power touch trigger system sends the instruction to the wireless interface adapter to reduce power for the antenna system or antenna systems where a touch event has been detected within a nearby threshold distance. The wireless interface adapter module will reduce power for transmission or put the corresponding antenna system in standby mode depending on the instruction received. In an example embodiment, determination that a touch event has fallen with a first threshold distance, such as 10 cm, may invoke a first transmission power reduction state for operation of the antenna system. This device state may be communicated to the wireless interface adapter module to be implemented for the corresponding antenna system. In another example embodiment, a touch event detected within a second threshold, such as 5 cm, may invoke a second power reduction state for an even lower level power for operation of the antenna system. In yet another embodiment, a touch event indicating a third threshold such as 2 cm may invoke a third power reduction state, for example standby mode in one example embodiment, since a user appears to be touching or proximate to the location of the transmitting antenna system. Several variations on the power reduction measures and levels of distance thresholds are contemplated for use with the antenna power touch trigger system. In some embodiments (not shown), the antenna power touch trigger system may also send a signal to other concurrently operating antennas to increase power transmission level to the cumulative maximum allowed for the plural antenna systems if no nearby touch event was detected for those antennas. Thus, the efficacy of those other operating antenna systems may be increased with increased power while not impacting the overall cumulative transmission power under SAR regulation limits.

The antenna power touch trigger system will monitor at 625 ongoing data received from a touch controller via the PCH and BIOS as to whether a change in touch event has taken place or the touch event has ended. If the touch event has ended or changed such that the detected touch or proximity is outside a threshold for an antenna system, flow will proceed to 635. In an example embodiment, if the touch event has ended or changed so that no touch screen cell activated by a touch event within a threshold distance to trigger power reduction, the antenna power touch trigger system may instruct, via an API, the antenna system or systems so that the antenna or antennas may operate with a higher power level. Flow may return to 605 where the antenna power touch trigger system, via the touch screen controller monitoring for touch events will continue monitoring the touch screen.

It is understood that the methods and concepts described in the algorithm above for FIG. 6 may be performed in any sequence or steps may be performed simultaneously in some embodiments. It is also understood that in some varied embodiments certain steps may not be performed at all or additional steps not recited in the above figures may be performed. It is also contemplated that variations on the methods described herein may also be combined with portions of any other embodiments in the present disclosure to form a variety of additional embodiments. For example, aspects of FIGS. 5 and 6 may be modified as understood by those of skill to implement variations described therein from either figure embodiment.

In some embodiments, dedicated hardware implementations such as application specific integrated circuits, programmable logic arrays and other hardware devices can be constructed to implement one or more of the methods described herein or portions of one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The device or module can include software, including firmware embedded at a device, such as an Intel® Core™ or ARM® RISC brand processors, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An information handling system comprising:
a wireless adapter for communicating on an antenna system for connection to an operating wireless link;
a display having a touch screen interfacing with a touch screen controller to detect a touch event on the information handling system;
a processor executing code instructions for an antenna power touch trigger system for determining whether a location of the touch event is within a threshold distance to the antenna system; and
the antenna power touch trigger system communicating an instruction to reduce transmission power of the antenna system if the touch event is located within the threshold distance,
wherein the touch event is a detected touch or proximity of a user at a touch screen cell.

2. The information handling system of claim 1, wherein the touch screen is a capacitive touch screen system.

3. The information handling system of claim 1, further comprising:
a second antenna system for connection to a second operating wireless link;
the antenna power touch trigger system for determining whether the location of the touch event is within a second threshold distance to the second antenna system.

4. The information handling system of claim 1, further comprising:
the antenna power touch trigger system for determining whether a location of the touch event is within a second threshold distance to the antenna system; and
the antenna power touch trigger system communicating an instruction to reduce transmission power of the antenna system to a lower power level if the touch event is located within the second threshold distance.

5. The information handling system of claim 1, further comprising:
the wireless adapter reducing power to the antenna system in response to the instruction to reduce transmission power from the antenna power touch trigger system.

6. The information handling system of claim 1, wherein the instruction to reduce transmission power is an instruction to a wireless module to enter a reduced transmission power level via an API.

7. The information handling system of claim 6, wherein the instruction to reduce transmission power is an instruction to enter a first transmission power reduction state of a plurality of transmission power reduction states to reducing power to the antenna system by an intermediate level.

8. A computer implemented method comprising:
executing code instructions, via a processor, for an antenna power touch trigger system to receive indication of a touch event on a touch screen from a touch controller;
determining a plurality of usage modes for transmission via each of the first active wireless link and the second active wireless link;
referencing a touch cell location matrix to determine whether a location of the touch event at a touch screen cell is within a threshold distance to an antenna system mounted in an information handling system; and
communicating an instruction to reduce transmission power of the antenna system if the touch event is located within the threshold distance, wherein the touch event is a touch or proximity of a user detected at a touch screen cell.

9. The method of claim 8, further comprising:
monitoring the touch screen for changes in the touch screen event; and
communicating an instruction to increase transmission power of the antenna system if the touch event has ended.

10. The method of claim 8, further comprising:
monitoring the touch screen for changes in the touch screen event; and
communicating an instruction to increase transmission power of the antenna system if the touch event has moved outside of the threshold distance to the antenna system.

11. The method of claim 8, further comprising:
reducing transmission power to the antenna system via a wireless adapter in response to receiving an instruction to reduce transmission power of the antenna system if the touch event is located within the threshold distance.

12. The method of claim 8, further comprising:
communicating an instruction to increase transmission power of a second antenna system if the touch event is located outside a second threshold distance of the second antenna.

13. The method of claim 8, further comprising:
communicating an instruction to reduce transmission power of a second antenna system if the touch event is located within a second threshold distance of the second antenna.

14. The method of claim 13, further comprising:
reducing transmission power to the second antenna system via a second wireless adapter in response to receiving an instruction to reduce transmission power of the second antenna system if the touch event is located within the second threshold distance.

15. An information handling system comprising:
a wireless adapter for communicating on an antenna system for connection to an operating wireless link;
a touch screen interfacing with a touch screen controller to detect a touch event on the information handling system;
a processor executing code instructions for an antenna power touch trigger system for determining whether a location of the touch event is within a threshold distance to the antenna system; and
the antenna power touch trigger system communicating an instruction to a wireless adapter to enter a reduced transmission power state reducing a power state of the antenna system if the touch event is located within the threshold distance,
wherein the touch event is a detected touch or proximity of a user at a touch screen cell.

16. The information handling system of claim 15, further comprising:
the wireless adapter placing the antenna system into a first reduced transmission power state at an intermediate reduced power level in response to the instruction from the antenna power touch trigger system.

17. The information handling system of claim 16, further comprising:
antenna power touch trigger system determining whether the location of the touch event is within a second threshold distance to the antenna system; and
the antenna power touch trigger system communicating an instruction to enter a second reduced transmission power state at a second intermediate reduced power level lower than the first intermediate reduced power level in response reducing a power state of the antenna system if the touch event is located within the second threshold distance.

18. The information handling system of claim 17, further comprising:
the wireless adapter placing the antenna system into the second reduced transmission power state in response to the instruction received via an API from the antenna power touch trigger system.

19. The information handling system of claim 15, further comprising:
the antenna power touch trigger system determining whether the touch event has ended or the location of the touch event is outside the threshold distance to the antenna system;
the antenna power touch trigger system communicating an instruction to return to a transmission power state at full power to the antenna system if the touch event is located outside the threshold distance or the touch event has ended.

20. The information handling system of claim 19, further comprising:
the wireless adapter placing the antenna system into the full power transmission power state enabling maximum transmission power levels.
